(19) United States
(12) Patent Application Publication
(10) Pub. No.: US 2013/0256071 A1
(43) Pub. Date: Oct. 3, 2013

(54) METHOD OF BLEEDING A HYDRAULIC BRAKING SYSTEM

(71) Applicants: Kim Stephen Jones, Springfield (GB); Andrew Cookson, Wickford (GB)

(72) Inventors: Kim Stephen Jones, Springfield (GB); Andrew Cookson, Wickford (GB)

(73) Assignee: Ford Global Technologies, LLC

(21) Appl. No.: 13/622,440

(22) Filed: Sep. 19, 2012

(30) Foreign Application Priority Data
Oct. 13, 2011 (DE) 11184969.1

(51) Int. Cl. B60T 17/02

(52) U.S. Cl. CPC B60T 17/02
USPC 188/352

(57) ABSTRACT

A computer-implemented method of bleeding a hydraulic braking system during vehicle repair includes: receiving a designation of an affected brake component in the hydraulic braking system based on a vehicle diagnostic; and bleeding the affected brake component by actuating a hydraulic pump in the brake system via an in-vehicle control module.

### CROSS-REFERENCE TO RELATED APPLICATIONS

This application is a continuation and claims the benefit of European Patent Application No. EP 11184969.1 titled “Method of bleeding a hydraulic braking system” filed Oct. 13, 2011, which is hereby incorporated by reference in its entirety.

### TECHNICAL FIELD

The present invention relates to a method of bleeding a hydraulic braking system, in particular, to a method of bleeding a hydraulic braking system of a vehicle.

### BACKGROUND

Following the opening of any hydraulic connection in the braking system or during a brake fluid replacement, e.g. every two years, an affected portion of the braking system can be bled to remove any air that may have entered the system. This is currently accomplished by either a pressure bleeding system that forces fluid through the affected brake circuit or a manual system where a technician operates the brake pedal to move fluid through the braking system. The pressure bleeding system injects fluid under pressure into the braking system. It is only possible to bleed one braking circuit at a time. An operator has to look for the fluid running clear of air bubbles. When it is judged that the brake fluid is free of air bubbles the bleeding process is stopped.

The manual bleeding is accomplished by one operator forcing brake fluid through the braking system via operating the brake pedal through its full travel. A second operator giving instructions from underneath a vehicle looks for the fluid, e.g., running out of an opened bleeder screw at a brake caliper or brake cylinder. When there are no air bubbles in the fluid the operator inside the vehicle holds the brake pedal in a fully applied position while the second operator underneath the vehicle closes the bleeder screw on the brake.

There is still a third known method of bleeding a hydraulic braking system which is not a recommended practice but used extensively, called an “applied air pressure.” An air line is applied to the bleeder screw creating a venturi effect that pulls brake fluid through the brake circuit from a brake fluid reservoir. When there are no air bubbles in the brake fluid the operator switches off the pressure and tightens the bleeder screw.

All aforementioned systems are reliant on at least an operator and in some cases will not remove all of the air contained in the system.

It is therefore desirable to provide an improved air bleeding method for a hydraulic braking system by means of which air can be bled efficiently from the braking system. It is further desirable to reduce the operator's interventions necessary to carry out the bleeding process in order to make the bleeding of the braking system more reliable.

### SUMMARY

The present disclosure addresses one or more of the above-mentioned issues. Other features and/or advantages will become apparent from the description which follows.

One exemplary embodiment relates to a computer-implemented method of bleeding a hydraulic braking system during vehicle repair, including: receiving a designation of an affected brake component in the hydraulic braking system based on a vehicle diagnostic; and bleeding the affected brake component by actuating a hydraulic pump in the brake system via an in-vehicle control module.

One exemplary embodiment relates to a computer-implemented method of bleeding a hydraulic braking system, including: (i) receiving vehicle diagnostic data including a replaced brake component; (ii) associating the replaced brake component with a brake cylinder; (iii) opening a bleeder screw on the brake cylinder; (iv) starting a hydraulic pump using a vehicle electronic stability control system; (v) stopping the hydraulic pump; and (vi) closing the bleeder screw.

Another exemplary embodiment relates to a vehicle stability control system for use with bleeding a hydraulic brake system, including: a plurality of brake cylinders in fluid communication with a hydraulic pump and fluid reservoir; a bleeder screw associated with each cylinder in the plurality of cylinders; and a control unit configured to receive data related to a replacement part and assign a first brake cylinder in the plurality of brake cylinders to be bled based on the data. The control unit is further configured to open a bleeder screw associated with the first brake cylinder and actuate the hydraulic pump for bleeding.

One advantage of the present disclosure is that it provides an improved air bleeding method for a hydraulic braking system by means of which air can be bled efficiently from the braking system. It is further desirable to reduce the operator's interventions necessary to carry out the bleeding process in order to make the bleeding of the braking system more reliable.

### DETAILED DESCRIPTION

It is to be understood that the features disclosed in the following detailed description may be combined in any technically reasonable and practical way and disclose further embodiments of the present invention. A method of bleeding a hydraulic braking system, including: a hydraulic pump which, at its suction side, is in fluid conducting communication with a brake fluid reservoir and, at its pressure side, is in fluid conducting communication with at least a brake cylinder. A valve for opening and closing the fluid conducting communication is provided between the hydraulic pump and each brake cylinder. The method includes the following the following automated steps: providing brake fluid to the brake fluid reservoir while carrying out all subsequent steps, opening a bleeder screw on at least one brake cylinder, starting the hydraulic pump, opening and closing of at least a valve, stopping the hydraulic pump, and closing the bleeder screw. In one embodiment, the steps of starting and stopping the hydraulic pump and the steps of opening and closing the valve(s) are carried out by an electronic stability control system.

An electronic stability control (ESC) system of a vehicle is configured to draw brake fluid from a brake fluid reservoir and apply individual wheel brakes during an ESC or traction control event. This functionality is used to draw fresh brake fluid from the brake fluid reservoir and out of an open bleeder screw at a brake cylinder or brake caliper enabling air to be removed from the braking system. This process only requires one operator and looking for the presence of air bubbles in the brake fluid is not required. Utilizing the ESC system for carrying out the bleeding of the braking system facilitates the bleeding process to be carried out efficiently. No external equipment, such as an external pump or air line, has to be additionally provided or mounted to the braking system.

According to a preferred embodiment the brake fluid in the brake fluid reservoir is pressurized with a pressure preferably in the range of approximately 1 to 2 bars of primary pressure. Thus, the bleeding process can be carried out even more rapidly while ensuring a sufficient amount of brake fluid in the brake fluid reservoir. Conventional brake system pressure fillers can be used to provide the brake fluid to the fluid reservoir and pressurize the brake fluid in the reservoir.

In order for the bleeding process to be even efficiently carried out, the steps of starting and stopping a hydraulic pump and the steps of opening and closing the valve(s) are automatically initiated by means of a diagnostic program according to another preferred embodiment. Preferably the diagnostic program communicates with the electronic stability control system via an appropriate communication protocol such as CAN (controller area network), SCP or ISO 9141 etc. The diagnostic program or tool can, for example, take an appropriate decision which valves of the braking system operate, i.e. to open and to close, during the bleeding process depending on the replaced and/or opened parts of the braking system. The diagnostic tool can present the operator a parts list from which one chooses the renewed brake parts and, subsequently, the diagnostic tool only actuates the valves associated with an affected portion of the braking system, i.e., those that have to be bled.

In one exemplary embodiment, the ESX system is configured so that if a brake fluid change is to occur in the tandem master cylinder, the ABS ECU (anti-lock braking system electronic control unit), the ABS HCU (anti-lock braking system hydraulic control unit), or the brake tubes have been renewed, the front left, front right, rear left, and rear right brake circuits of a vehicle have to be bled. If only the front left caliper or the front left brake hose have been renewed, only the front left brake circuit has to be bled and therefore only the valves associated with the front left brake circuit might be operated by the diagnostic tool. If only the front right caliper or the front right brake hose have been renewed, only the front right brake circuit has to be bled and therefore only the valves associated with the front right brake circuit might be operated by the diagnostic tool. If only the rear left caliper or the rear left brake hose have been renewed, only the rear left brake circuit has to be bled and therefore only the valves associated with the rear left brake circuit might be operated by the diagnostic tool. If only the rear right caliper or the rear right brake hose have been renewed only the rear right brake circuit has to be bled and therefore only the valves associated with the rear right brake circuit are operated by the diagnostic tool. It is to be understood that in a very simple approach of operating the valves of the braking system the diagnostic program can operate all the valves of the braking system irrespective of the replaced and/or opened parts of the braking system. Thus, the parts that have been replaced and/or opened are used by the diagnostic program only to instruct the operator which bleeding screw to open and close when and at which brake caliper or brake cylinder.

In order to reach hard to bleed portions of the braking system it may be appropriate to sequentially open and close all valves of the braking system during the steps of opening and closing the valve(s), i.e. only one valve of the braking system is opened and closed before the next valve of the braking system is opened and closed. This facilitates fresh brake fluid being drawn through every portion of the braking system and, thus, ensures that all air is removed from the braking system.

In another embodiment, the steps of opening and closing the valve(s) comprise opening and closing all valves of the braking system at the same time. Thus, the method of bleeding the hydraulic braking system can be carried out in a relatively quick manner while still ensuring that fresh brake fluid is drawn through every portion of the braking system and all air is removed therefrom.

In another embodiment, the steps of opening and closing the valve(s) are carried out multiple times in rapid succession, thus pressure pulsations are created in the braking system to eliminate air bubbles. The same effect is achieved when the pump is repeatedly started and stopped in rapid succession.

Looking for the presence of air bubbles in the brake fluid is no longer required. It is even possible to bleed more than one brake circuit at a time. Hence, if the hydraulic braking system comprises two brake cylinders which are associated with two different brake circuits of the braking system the steps of opening and closing the bleeder screw comprise opening and closing the bleeder screw on the two brake cylinders associated with the two different brake circuits at the same time. This cuts the time in half to carry out the bleeding of a complete braking system with more than one brake circuits as compared to other bleeding methods.

To ensure the complete removal of air bubbles from the braking system and to still be efficient the steps of starting and stopping the hydraulic pump and the steps of opening and closing the valve(s) are carried out for a predetermined period of time. According to the present invention this period of time is preferably about 20 seconds.

According to yet another embodiment a step of waiting for a predetermined time after the last step of closing the bleeder screw is carried out is executed. Preferably, the amount of time is approximately 120 seconds. This ensures that there is enough time for the ESC system, particularly the pump and the valves, to cool down which is especially important if another bleeding process is to be started, for example, to bleed another brake circuit.

The method of bleeding a hydraulic braking system is used to bleed the braking system of a vehicle; the braking system consists of at least two different and independent brake circuits.

We claim:

1. A computer-implemented method of bleeding a hydraulic braking system during vehicle repair, comprising:
receiving a designation of an affected brake component in the hydraulic braking system based on a vehicle diagnostic; and
bleeding the affected brake component by actuating a hydraulic pump in the brake system via an in-vehicle control module.

2. The method of claim 1, further comprising:
designating the affected brake component in the hydraulic braking system based on the vehicle diagnostic.

3. The method of claim 2, wherein the designating the affected brake component includes referencing a replacement parts list and designating a brake cylinder associated with the brake component to be replaced as the affected brake component.

4. The method of claim 3, wherein when the replacement parts list includes a brake caliper, brake cylinder or brake hose.

5. The method of claim 1, further comprising:
hydraulically isolating an unaffected brake component from a master cylinder.

6. The method of claim 5, wherein isolating the unaffected brake cylinder includes: closing a bleed valve in communication with the unaffected brake cylinder.

7. The method of claim 1, wherein the actuating a hydraulic pump is done for a time period less than or equal to 20 seconds.

8. A computer-implemented method of bleeding a hydraulic braking system, comprising:
(i) receiving vehicle diagnostic data including a replaced brake component;
(ii) associating the replaced brake component with a brake cylinder;
(iii) opening a bleeder screw on the brake cylinder;
(iv) starting a hydraulic pump using a vehicle electronic stability control system;
(v) stopping the hydraulic pump; and
(vi) closing the bleeder screw.

9. The method of claim 8, further comprising:
pumping brake fluid from the bleeder screw to a brake fluid reservoir.

10. The method of claim 9, further comprising:
pressurizing the brake fluid in the reservoir to at least 1 bar.

11. The method of claim 8, further comprising:
actuating a control valve isolating other brake cylinders using the electronic stability control system.

12. The method of claim 8, further comprising:
sequentially opening and closing a plurality of valves of in the braking system.

13. The method of claim 8, further comprising:
opening and closing a plurality of valves in the braking system at the same time.

14. The method of claim 8, wherein stopping the hydraulic pump is carried out a predetermined time period after starting the hydraulic pump.

15. The method of claim 14, wherein the predetermined time period is 20 seconds.

16. The method of claim 8, further comprising:
delaying brake system use until expiration of a predetermined time period;
wherein the predetermined time period is at least 100 seconds.

17. A vehicle stability control system for use with bleeding a hydraulic brake system, comprising:
a plurality of brake cylinders in fluid communication with a hydraulic pump and fluid reservoir;
a bleeder screw associated with each cylinder in the plurality of cylinders;
and a control unit configured to receive data related to a replacement part and assign a first brake cylinder in the plurality of brake cylinders to be bled based on the data;
wherein the control unit is further configured to open a bleeder screw associated with the first brake cylinder and actuate the hydraulic pump for bleeding.

18. The vehicle stability control system of claim 17, further comprising:
a valve configured to isolate the remaining brake cylinders in the plurality of brake cylinders from the pump when the first brake cylinder is bled;
wherein the control unit is configured to control the valve.

19. The vehicle stability control system of claim 17, wherein the control unit is configured to close the bleeder screws.

20. The vehicle stability control system of claim 17, further comprising:
a timer in the control unit configured to activate and deactivate system functions according to predetermined time limits.
